(19) United States
(12) Patent Application Publication
(10) Pub. No.: US 2006/0094637 A1
(43) Pub. Date: May 4, 2006

(54) Deruster composition and method

(75) Inventors: Jeng-Li Liang, Auburn Hills, MI (US); William E. Fristad, Rochester Hills, MI (US)

Correspondence Address: WOODCOCK WASHBURN LLP, ONE LIBERTY PLACE, 46TH FLOOR, PHILADELPHIA, PA, 19103, US

(73) Assignee: Henkel Kommanditgesellschaft auf Aktien (Henkel KGaA), Duesseldorf (DE)

(21) Appl. No.: 11/261,724

(22) Filed: Oct. 28, 2005

Related U.S. Application Data
(60) Provisional application No. 60/623,500, filed on Oct. 28, 2004.

(51) Int. Cl. C11D 3/37

(52) U.S. Cl. 510/499

(57) ABSTRACT

The present invention relates to compositions comprising phosphonate metal chelants, chelating agents, and ferrous ions at a pH of about 5 to about 10, and methods of using the compositions.

### FIELD OF THE INVENTION

The present invention relates to derusting compositions useful for the removal of rust from surfaces, and methods of using the same.

### BACKGROUND OF THE INVENTION

Derusting compositions are a staple for use in certain industries, such as remanufacturing. Typically, components are immersed in conventional, high temperature molten salt bath formulations to remove aged layers of deposits such as dirt and paint from their surfaces. However, such formulations fail to remove rust. Moreover, after quenching the cleaned components with water, new flash rust is generated on any clean surface not already covered with old rust.

Thus, the rusted components have to be treated to remove both old and new rust from the engine surface. In the past, neutral pH derusters were used. However, the pH of a neutral deruster bath usually rises quickly because protons (H⁺) in the bath are consumed by reaction with iron oxide (FeₓO_{y}) during the derusting operation. The bath is also gradually loaded with alkaline salt dragout from molten bath. Since neutral pH derusters lose their ability to remove rust when the pH of the bath is high, pH adjustments are constantly needed to maintain a neutral pH. Therefore, what is needed is a deruster that is efficacious at pH levels at and above neutral.

### SUMMARY OF THE INVENTION

The compositions of the present invention can be used as derusters which are stable and effective at a pH of at least about 5. The compositions of this invention thus eliminate labor-intensive pH adjustments, and reduce remanufacturing costs.

In one embodiment, compositions having a pH ranging from about 5 to about 10 comprising, phosphonic acid metal chelants, chelant stabilizers, and ferrous ions are disclosed.

In another embodiment, methods of derusting surfaces by treatment with compositions of the present invention are disclosed.

### DETAILED DESCRIPTION OF ILLUSTRATIVE EMBODIMENTS

The present invention is directed to compositions and methods of using the same as derusters.

In one embodiment of the present invention, the composition comprises:
(a) a phosphonate metal chelant,
(b) at least one chelating agent, provided that when only one chelating agent is present, the chelating agent is other than EDTA;
(c) ferrous ions; and
(d) a pH ranging from about 5 to about 10.

The term “phosphonate metal chelant” refers to phosphonates which remove metal oxides by forming water soluble metal complexes. A phosphonate metal chelant includes any compound that contains a phosphonate functional group and a second functional group capable of coordinating to a metal ion, e.g., a second phosphonate group, a carboxylic acid group, or an alcoholic —OH group. In one embodiment, the phosphonate metal chelant is at least one of 1-hydroxyethylidene-1,1-diphosphonic acid, amino tri(methylene-phosphonic acid), hexamethylenediamine tetra(methylene-phosphonic acid), 2-phosphonobutane-1,2,4-tricarboxylic acid, ethylenediamine tetra(methylene-phosphonic acid), diethylenetriamine penta(methylene-phosphonic acid), hydroxymethylphosphonic acid, amino(methylenephosphonic acid), iminobis(methylenephosphonic acid), nitrilotris(methylenephosphonic acid), ethylenedinitrilotetrakis (methylenephosphonic acid), diethylenetrinitrilopentakis (methylene-phosphonic acid), or salts thereof. In one embodiment, the phosphonate metal chelant is a phosphonate, such as is available from Solutia Inc., St. Louis, Mo., under the tradename DEQUEST®. Preferably, the phosphonate metal chelant is a diphosphonic acid or salt thereof, including 1-hydroxyethylidene-1,1-diphosphonic acid, 1-hydroxyethylidene-1,1-diphosphonic acid tetrasodium salt, amino tri(methylene-phosphonic acid), amino tri(methylene-phosphonic acid) pentasodium salt, hexamethylenediamine tetra(methylene-phosphonic acid) potassium salt, diethylenetriamine penta(methylene-phosphonic acid), diethylenetriamine penta(methylene-phosphonic acid) trisodium salt, 2-phosphonobutane-1,2,4-tricarboxylic acid, and ethylenediamine tetra(methylene-phosphonic acid) pentasodium salt.

In one embodiment, the phosphonate metal chelant is present in a range from about 1% by weight of the composition to about 60% by weight of the composition. It is understood that each recited range in this specification includes all combinations and subcombinations of ranges, as well as specific numerals contained therein. Preferably, the phosphonate metal chelant is present in a range from about 2% by weight of the composition to about 40% by weight of the composition. More preferably, the phosphonate metal chelant is present in a range from about 3% by weight of the composition to about 30% by weight of the composition.

The term “chelating agent” refers to chelators that form water soluble metal complexes. The complex formed may be less stable, more stable, or as stable as the phosphonate metal chelant. In one embodiment, the chelating agent is a chelating agent, such as is available from Dow Chemical, under the tradename VERSENE®. In another embodiment, the chelating agent is an alkanolamine. Preferably, the chelating agent includes at least one alkanolamine, including, but not limited to, triethanolamine (“TEA”), monoethanolamine (“MEA”), N-(hydroxyethyl)-ethylenediamine triacetic acid (“HEDTA”), monoisopropanolamine (“MIPA”), diethanolamine (“DEA”), aminoethylethanolamine (“AEEA”), diethylenetriaminepentaacetic acid (“DTPA”), 1,2-diaminopropanetetraacetic acid (“1,2-PDTA”), 1,3-diaminopropanetetraacetic acid (“1,3-PDTA”), and the like, or salts thereof. When the chelating agent is at least one of triethanolamine (“TEA”), monoethanolamine (“MEA”), N-(hydroxyethyl)-ethylenediamine triacetic acid (“HEDTA”), monoisopropanolamine (“MIPA”), diethanolamine (“DEA”), aminoethylethanolamine (“AEEA”), diethylenetriaminepentaacetic acid (“DTPA”), 1,2-diaminopropanetetraacetic acid (“1,2-PDTA”), 1,3-diaminopropanetetraacetic acid (“1,3-PDTA”), or salts thereof, the chelating agent may also include ethylenediamine tertraacetic acid (“EDTA”) as a second chelator.

In one embodiment, the chelating agent is present in a range from about 0.3% by weight of the composition to about 40% by weight of the composition. Preferably, the chelating agent is present in a range from about 0.5% by weight of the composition to about 30% by weight of the composition. More preferably, the chelating agent is present in a range from about 0.7% by weight of the composition to about 20% by weight of the composition.

In another embodiment, the composition comprises ferrous ions. Preferably, the ferrous ions are provided by ferrous sulfate. The ferrous ions accelerate the removal of metal oxides produced by the composition.

In one embodiment, the ferrous ions are present in a range from about 0.01% by weight of the composition to about 1.0% by weight of the composition. Preferably, the ferrous ions are present in a range from about 0.02% by weight of the composition to about 0.8% by weight of the composition. More preferably, the ferrous ions are present in a range from about 0.03% by weight of the composition to about 0.4% by weight of the composition.

Compositions of the present invention are efficacious in solutions with pHs of at least about 5. Preferably, the pH ranges from about 5 to about 10. More preferably, the pH ranges from about 5 to about 9. Yet more preferably, the pH ranges from about 6 to about 8.

Compositions of the present invention can be used over a wide range of temperatures, ranging from ambient temperatures to 150° F. Preferably, the temperature ranges from about 100° F. to about 120° F.

In one embodiment, the composition further comprises water. Preferably, the water is present in a range of from about 60% by weight of the composition to about 95% by weight of the composition.

In another embodiment of the present invention, a method is described for derusting components comprising:
contacting a rusted surface with a composition comprising:
   (a) a phosphonate metal chelant,
   (b) at least one chelating agent, provided that when only one chelating agent is present, the chelating agent is other than EDTA;
   (c) ferrous ions; and
   (d) a pH ranging from about 5 to about 10.

The step of contacting may be carried out by any conventional method, including, but not limited to, immersion and spray methods. The step of contacting is performed such that the rusted surface is at least partially dissolved. The step of contacting is performed for a time sufficient to derust a rusted surface. Preferably, the step of contacting is performed for about 10 minutes to about 50 minutes.

The term “phosphonate metal chelant” refers to phosphonates which remove metal oxides by forming water soluble metal complexes. A phosphonate metal chelant includes any compound that contains a phosphonate functional group and a second functional group capable of coordinating to a metal ion, e.g., a second phosphonate group, a carboxylic acid group, or an alcoholic —OH group. In one embodiment, the phosphonate metal chelant is at least one of 1-hydroxyethylidene-1,1-diphosphonic acid, amino tri(methylene-phosphonic acid), hexamethylenediamine tetra(methylene-phosphonic acid), 2-phosphonobutane-1,2,4-tricarboxylic acid, ethylenediamine tetra(methylene-phosphonic acid), diethylenetriamine penta(methylene-phosphonic acid), hydroxymethylphosphonic acid, amino(methylenephosphonic acid), iminobis(methylenephosphonic acid), nitrilotris(methylenephosphonic acid), ethylenedinitrilotetrakis (methylenephosphonic acid), diethylenetrinitrilopentakis (methylene-phosphonic acid), or salts thereof. In one embodiment, the phosphonate metal chelant is a phosphonate, such as is available from Solutia Inc., St. Louis, Mo., under the tradename DEQUEST®. Preferably, the phosphonate metal chelant is a diphosphonic acid or salt thereof, including 1-hydroxyethylidene-1,1-diphosphonic acid, 1-hydroxyethylidene-1,1-diphosphonic acid tetrasodium salt, amino tri(methylene-phosphonic acid), amino tri(methylene-phosphonic acid) pentasodium salt, hexamethylenediamine tetra(methylene-phosphonic acid) potassium salt, diethylenetriamine penta(methylene-phosphonic acid), diethylenetriamine penta(methylene-phosphonic acid) trisodium salt, 2-phosphonobutane-1,2,4-tricarboxylic acid, and ethylenediamine tetra(methylene-phosphonic acid) pentasodium salt.

In one embodiment, the phosphonate metal chelant is present in a range from about 1% by weight of the composition to about 60% by weight of the composition. It is understood that each recited range in this specification includes all combinations and subcombinations of ranges, as well as specific numerals contained therein. Preferably, the phosphonate metal chelant is present in a range from about 2% by weight of the composition to about 40% by weight of the composition. More preferably, the phosphonate metal chelant is present in a range from about 3% by weight of the composition to about 30% by weight of the composition.

The term “chelating agent” refers to chelators that form water soluble metal complexes. The complex formed may be less stable, more stable, or as stable as the phosphonate metal chelant. In one embodiment, the chelating agent is a chelating agent, such as is available from Dow Chemical, under the tradename VERSENE®. In another embodiment, the chelating agent is an alkanolamine. Preferably, the chelating agent includes at least one alkanolamine, including, but not limited to, triethanolamine (“TEA”), monoethanolamine (“MEA”), N-(hydroxyethyl)-ethylenediamine triacetic acid (“HEDTA”), monoisopropanolamine (“MIPA”), diethanolamine (“DEA”), aminoethylethanolamine (“AEEA”), diethylenetriaminepentaacetic acid (“DTPA”), 1,2-diaminopropanetetraacetic acid (“1,2-PDTA”), 1,3-diaminopropanetetraacetic acid (“1,3-PDTA”), and the like, or salts thereof. When the chelating agent is at least one of triethanolamine (“TEA”), monoethanolamine (“MEA”), N-(hydroxyethyl)-ethylenediamine triacetic acid (“HEDTA”), monoisopropanolamine (“MIPA”), diethanolamine (“DEA”), aminoethylethanolamine (“AEEA”), diethylenetriaminepentaacetic acid (“DTPA”), 1,2-diaminopropanetetraacetic acid (“1,2-PDTA”), 1,3-diaminopropanetetraacetic acid (“1,3-PDTA”), or salts thereof, the chelating agent may also include ethylenediamine tertraacetic acid (“EDTA”) as a second chelator.

In one embodiment, the chelating agent is present in a range from about 0.3% by weight of the composition to about 40% by weight of the composition. Preferably, the chelating agent is present in a range from about 0.5% by weight of the composition to about 30% by weight of the composition. More preferably, the chelating agent is present in a range from about 0.7% by weight of the composition to about 20% by weight of the composition.

In another embodiment, the composition comprises ferrous ions. Preferably, the ferrous ions are provided by ferrous sulfate. The ferrous ions accelerate the removal of metal oxides produced by the composition.

In one embodiment, the ferrous ions are present in a range from about 0.01% by weight of the composition to about 1.0% by weight of the composition. Preferably, the ferrous ions are present in a range from about 0.02% by weight of the composition to about 0.8% by weight of the composition. More preferably, the ferrous ions are present in a range from about 0.03% by weight of the composition to about 0.4% by weight of the composition.

Compositions of the present invention are efficacious in solutions with pHs of at least about 5. Preferably, the pH ranges from about 5 to about 10. More preferably, the pH ranges from about 5 to about 9. Yet more preferably, the pH ranges from about 6 to about 8.

Compositions of the present invention can be used over a wide range of temperatures, ranging from ambient temperatures to 150° F. Preferably, the temperature ranges from about 100° F. to about 120° F.

In one embodiment, the composition further comprises water. Preferably, the water is present in a range of from about 60% by weight of the composition to about 95% by weight of the composition.

In one embodiment, the rusted surface may be on an engine or engine parts. Engines are commonly used to power heavy-duty construction equipment and vehicles. An entire industry has been built around the practice of remanufacturing used engines. As can be appreciated, the surfaces of the used engines are typically in poor condition, and often one or more layers of contaminants have been deposited on the engine surfaces. Typical contaminants include paint, dirt, grime, oil, grease, and or rust. These contaminants must be removed during the remanufacturing process. Typically, engine components are immersed in conventional, high temperature molten salt bath formulations to remove most contaminants, but not rust, from the engine surfaces. Thus, the old rust still must be removed. Moreover, after quenching the newly cleaned parts with water, new flash rust is generated on any clean surface not already covered with old rust. Therefore, these rusted engine components have to be treated in some manner to remove all rust from the engine surface. Thus, in yet another embodiment of the present invention, a method is described for derusting engine surfaces comprising:
contacting the rusted surface with a composition comprising:
   (a) a phosphonate metal chelant;
   (b) at least one chelating agent, provided that when only one chelating agent is present, the chelating agent is other than EDTA;
   (c) ferrous ions; and
   (d) a pH ranging from about 5 to about 10.

The step of contacting may be carried out by any conventional method, including, but not limited to, immersion and spray methods. The step of contacting is performed such that the rusted surface is at least partially dissolved. The step of contacting is performed for a time sufficient to derust a rusted surface. Preferably, the step of contacting is performed for about 10 minutes to about 50 minutes.

The term “phosphonate metal chelant” refers to phosphonates which remove metal oxides by forming water soluble metal complexes. A phosphonate metal chelant includes any compound that contains a phosphonate functional group and a second functional group capable of coordinating to a metal ion, e.g., a second phosphonate group, a carboxylic acid group, or an alcoholic —OH group. In one embodiment, the phosphonate metal chelant is at least one of 1-hydroxyethylidene-1,1-diphosphonic acid, amino tri(methylene-phosphonic acid), hexamethylenediamine tetra(methylene-phosphonic acid), 2-phosphonobutane-1,2,4-tricarboxylic acid, ethylenediamine tetra(methylene-phosphonic acid), diethylenetriamine penta(methylene-phosphonic acid), hydroxymethylphosphonic acid, amino(methylenephosphonic acid), iminobis(methylenephosphonic acid), nitrilotris(methylenephosphonic acid), ethylenedinitrilotetrakis (methylenephosphonic acid), diethylenetrinitrilopentakis (methylene-phosphonic acid), or salts thereof. In one embodiment, the phosphonate metal chelant is a phosphonate, such as is available from Solutia Inc., St. Louis, Mo., under the tradename DEQUEST®. Preferably, the phosphonate metal chelant is a diphosphonic acid or salt thereof, including 1-hydroxyethylidene-1,1-diphosphonic acid, 1-hydroxyethylidene-1,1-diphosphonic acid tetrasodium salt, amino tri(methylene-phosphonic acid), amino tri(methylene-phosphonic acid) pentasodium salt, hexamethylenediamine tetra(methylene-phosphonic acid) potassium salt, diethylenetriamine penta(methylene-phosphonic acid), diethylenetriamine penta(methylene-phosphonic acid) trisodium salt, 2-phosphonobutane-1,2,4-tricarboxylic acid, and ethylenediamine tetra(methylene-phosphonic acid) pentasodium salt.

In one embodiment, the phosphonate metal chelant is present in a range from about 1% by weight of the composition to about 60% by weight of the composition. It is understood that each recited range in this specification includes all combinations and subcombinations of ranges, as well as specific numerals contained therein. Preferably, the phosphonate metal chelant is present in a range from about 2% by weight of the composition to about 40% by weight of the composition. More preferably, the phosphonate metal chelant is present in a range from about 3% by weight of the composition to about 30% by weight of the composition.

The term “chelating agent” refers to chelators that form water soluble metal complexes. The complex formed may be less stable, more stable, or as stable as the phosphonate metal chelant. In one embodiment, the chelating agent is a chelating agent, such as is available from Dow Chemical, under the tradename VERSENE®. In another embodiment, the chelating agent is an alkanolamine. Preferably, the chelating agent includes at least one alkanolamine, including, but is not limited to, triethanolamine (“TEA”), monoethanolamine (“MEA”), N-(hydroxyethyl)-ethylenediamine triacetic acid (“HEDTA”), monoisopropanolamine (“MIPA”), diethanolamine (“DEA”), aminoethylethanolamine (“AEEA”), diethylenetriaminepentaacetic acid (“DTPA”), 1,2-diaminopropanetetraacetic acid (“1,2-PDTA”), 1,3-diaminopropanetetraacetic acid (“1,3-PDTA”), and the like, or salts thereof. When the chelating agent is at least one of triethanolamine (“TEA”), monoethanolamine (“MEA”), N-(hydroxyethyl)-ethylenediamine triacetic acid (“HEDTA”), monoisopropanolamine (“MIPA”), diethanolamine (“DEA”), aminoethylethanolamine (“AEEA”), diethylenetriaminepentaacetic acid (“DTPA”), 1,2-diaminopropanetetraacetic acid (“1,2-PDTA”), 1,3-diaminopropanetetraacetic acid (“1,3-PDTA”), or salts thereof, the chelating agent may also include ethylenediamine tertraacetic acid (“EDTA”) as a second chelator.

In one embodiment, the chelating agent is present in a range from about 0.3% by weight of the composition to about 40% by weight of the composition. Preferably, the chelating agent is present in a range from about 0.5% by weight of the composition to about 30% by weight of the composition. More preferably, the chelating agent is present in a range from about 0.7% by weight of the composition to about 20% by weight of the composition.

In another embodiment, the composition comprises ferrous ions. Preferably, the ferrous ions are provided by ferrous sulfate. The ferrous ions accelerate the removal of metal oxides produced by the composition.

In one embodiment, the ferrous ions are present in a range from about 0.01% by weight of the composition to about 1.0% by weight of the composition. Preferably, the ferrous ions are present in a range from about 0.02% by weight of the composition to about 0.8% by weight of the composition. More preferably, the ferrous ions are present in a range from about 0.03% by weight of the composition to about 0.4% by weight of the composition.

Compositions of the present invention are efficacious in solutions with pHs of at least about 5. Preferably, the pH ranges from about 5 to about 10. More preferably, the pH ranges from about 5 to about 9. Yet more preferably, the pH ranges from about 6 to about 8.

Compositions of the present invention can be used over a wide range of temperatures, ranging from ambient temperatures to 150° F. Preferably, the temperature ranges from about 100° F. to about 120° F.

In one embodiment, the composition further comprises water. Preferably, the water is present in a range of from about 60% by weight of the composition to about 95% by weight of the composition.

After derusting, the cleaned engine components can then be rinsed with a rust preventive product such as P3 PREVOX® 505, commercially available from Henkel Surface Technologies, Madison Heights, Mich., to prevent flash rusting during subsequent storage.

The present invention is further described in the following examples.

### EXAMPLES

### Example 1

A. Two commercially available derusting compositions were prepared.

Standard 1 was comprised of 83.61 g water, 8.88 g DEQUEST® 2010, a 60% 1-hydroxyethylidene-diphosphonic acid solution available from Solutia Inc., St. Louis, Mo., 0.17 g ferrous sulfate heptahydrate (“ferrous sulfate”), and 7.34 g Caustic Potash (“KOH”) (45% solution). The composition is listed in TABLE 1 as “Std. 1.”

Standard 2 was comprised of 82.12 g water, 1.49 g VERSENE® 100, a 39% tetrasodium ethylenediamine tetraacetic acid salt solution available from Dow Chemical, 8.88 g DEQUEST® 2010 60% 1-hydroxyethylidene-diphosphonic acid solution, 0.17 g ferrous sulfate, and 7.34 g KOH (45% solution). The composition is listed in TABLE 1 as “Std. 2.”

B. Six compositions of the present invention were prepared.

Composition 1 was comprised of 82.59 g water, 1.02 g triethanolamine (“TEA”), 8.88 g DEQUEST® 2010 60% 1-hydroxyethylidene-diphosphonic acid solution, 0.17 g ferrous sulfate, and 7.34 g KOH (45% solution). The composition is listed in TABLE 1 as “Com. 1.”

Composition 2 was comprised of 81.1 g water, 1.49 g VERSENE® 100 39% tetrasodium ethylenediamine tetraacetic acid salt solution, 1.02 g TEA, 8.88 g DEQUEST® 2010 60% 1-hydroxyethylidene-diphosphonic acid solution, 0.17 g ferrous sulfate, and 7.34 g KOH (45% solution). The composition is listed in TABLE 1 as “Com. 2.”

Composition 3 comprised 79.84 g water, 2.24 g VERSENE® 100 39% tetrasodium ethylenediamine tetraacetic acid salt solution, 1.53 g TEA, 8.88 g DEQUEST® 2010 60% 1-hydroxyethylidene-diphosphonic acid solution, 0.17 g ferrous sulfate, and 7.34 g KOH (45% solution). The composition is listed in TABLE 1 as “Com. 3.”

Composition 4 comprised 82.08 g water, 1.53 g TEA, 8.88 g DEQUEST® 2010 60% 1-hydroxyethylidene-diphosphonic acid solution, 0.17 g ferrous sulfate, and 7.34 g KOH (45% solution). The composition is listed in TABLE 1 as “Com. 4.”

Composition 5 comprised 82.08 g water, 1.53 g monoethanolamine (“MEA”), 8.88 g DEQUEST® 2010 60% 1-hydroxyethylidene-diphosphonic acid solution, 0.17 g ferrous sulfate, and 7.34 g KOH (45% solution). The composition is listed in TABLE 1 as “Com. 5.”

Composition 6 comprised 82.09 g water, 0.76 g TEA, 0.76 g MEA, 8.88 g DEQUEST® 2010 60% 1-hydroxyethylidene-diphosphonic acid solution, 0.17 g ferrous sulfate, and 7.34 g KOH (45% solution). The composition is listed in TABLE 1 as “Com. 6.”

In the order of mixing the above compositions, when present, VERSENE® 100 39% tetrasodium ethylenediamine tetraacetic acid salt solution, TEA, and or MEA was added to water and stirred. Next, DEQUEST® 2010 60% 1-hydroxyethylidene-diphosphonic acid solution was added with mixing until completely dissolved. Then ferrous sulfate and KOH were added, and the mixture was stirred until a clear solution was obtained.

TABLE 1

| | Std. 1 | Std. 2 | Com. 1 | Com. 2 | Com. 3 | Com. 4 | Com. 5 | Com. 6 |
|---|---|---|---|---|---|---|---|---|
| Water | 83.61 | 82.12 | 82.59 | 81.1 | 79.84 | 82.08 | 82.08 | 82.09 |
| VERSENE^{®}100 | 0 | 1.49 | 0 | 1.49 | 2.24 | 0 | 0 | 0 |
| TEA | 0 | 0 | 1.02 | 1.02 | 1.53 | 1.53 | 0 | 0.76 |
| MEA | 0 | 0 | 0 | 0 | 0 | 0 | 1.53 | 0.76 |
| DEQUEST^{®}2010 | 8.88 | 8.88 | 8.88 | 8.88 | 8.88 | 8.88 | 8.88 | 8.88 |
| Ferrous Sulfate | 0.17 | 0.17 | 0.17 | 0.17 | 0.17 | 0.17 | 0.17 | 0.17 |
| KOH | 7.34 | 7.34 | 7.34 | 7.34 | 7.34 | 7.34 | 7.34 | 7.34 |

### Example 2

The compositions from EXAMPLE 1 were tested to determine their derusting capability over a variety of pH ranges, 6.5, 8, 10, 13, and 13.9. When necessary, 45% KOH was added to increase the pH.

Once the desired pH was obtained, the compositions were each heated to 120° F., with stirring. Then 1 g rust powder was added, the rust having been collected from cold rolled steel panels after being exposed to 500 hours of salt fog. The temperature of the mixtures was maintained at 120° F. for 20 minutes. The mixture was then filtered and amount of iron dissolved in the filtrate was measured using an ASOMA X-ray fluorescence spectrometer from Spectro Analytical Instruments GmbH & Co. KGaA, Kleve, Germany. The results are presented below in Table 2 in ppm dissolved iron.

TABLE 2

| | pH 6.5 | pH 8 | pH 10 | pH 13 | pH 13.9 |
|---|---|---|---|---|---|
| Std. 1 | 219 | 217 | 156 | 102 | 20 |
| Std. 2 | 216 | 207 | 161 | 107 | 29 |
| Com. 1 | 295 | 239 | 189 | 109 | 179 |
| Com. 2 | 225 | 214 | 181 | 111 | 159 |
| Com. 3 | 312 | 283 | 225 | 139 | 184 |
| Com. 4 | 252 | 244 | 231 | 145 | 213 |
| Com. 5 | 236 | 228 | 235 | 199 | 95 |
| Com. 6 | 243 | 212 | 195 | 140 | 178 |

TABLE 2 clearly shows that the compositions of the present invention dissolved more iron oxide than the commercially available products with the exception of two compositions at pH 8. The compositions of the present invention were dramatically more effective than the commercially available products at pH≧13. Although the inventors do not wish to be bound by any theory of operation, it is evident from TABLE 2 that simple diphosphonic acid formulations like the commercially available products are no longer able to dissolve iron oxide at pH values above 13.

Moreover, this lack of performance is significant, as in some remanufacturing applications, molten salt dragout with the engine components loads the derusting bath with alkali, the pH of the bath increases rapidly to >13. As shown in TABLE 2, the compositions of the present invention are effective at pH>13.

The disclosures of each patent, patent application, and publication cited or described in this document are hereby incorporated herein by reference, in their entireties.

Various modifications of the invention, in addition to those described herein, will be apparent to those skilled in the art from the foregoing description. Such modifications are also intended to fall within the scope of the appended claims.

What is claimed:

1. A composition, comprising:
(a) a phosphonate metal chelant;
(b) at least one chelating agent stabilizer, provided that when only one chelating agent is present, the chelating agent is other than EDTA;
(c) ferrous ions; and
(d) a pH ranging from about 5 to about 10.

2. The composition of claim 1, wherein the ferrous ions are present in a range of from about 0.01% by weight of the composition to about 1.0% by weight of the composition.

3. The composition of claim 1, wherein the ferrous ions are present in a range of from about 0.02% by weight of the composition to about 0.8% by weight of the composition.

4. The composition of claim 1, wherein the ferrous ions are present in a range of from about 0.03% by weight of the composition to about 0.4% by weight of the composition.

5. The composition of claim 1, further comprising water.

6. The composition of claim 5, wherein the water is present in a range of from about 60% by weight of the composition to about 95% by weight of the composition.

7. The composition of claim 1, wherein the phosphonate metal chelant is at least one of 1-hydroxyethylidene-1,1-diphosphonic acid, amino tri(methylene-phosphonic acid), hexamethylenediamine tetra(methylene-phosphonic acid), 2-phosphonobutane-1,2,4-tricarboxylic acid, ethylenediamine tetra(methylene-phosphonic acid), diethylenetriamine penta(methylene-phosphonic acid), hydroxymethylphosphonic acid, amino(methylene-phosphonic acid), iminobis(methylenephosphonic acid), nitrilotris(methylene-phosphonic acid), ethylenedinitrilotetrakis (methylenephosphonic acid), diethylenetrinitrilopentakis (methylene-phosphonic acid), or salts thereof.

8. The composition of claim 1, wherein the phosphonate metal chelant is at least one of a diphosphonic acid or a diphosphonic acid salt selected from the group comprising 1-hydroxyethylidene-1,1-diphosphonic acid, 1-hydroxyethylidene-1,1-diphosphonic acid tetra-sodium salt, amino tri(methylene-phosphonic acid), amino tri(methylene-phosphonic acid) pentasodium salt, hexamthylenediamine tetra(methylene-phosphonic acid) potassium salt, diethylenetriamine penta(methylene-phosphonic acid), diethylenetriamine penta(methylene-phosphonic acid) trisodium salt, 2-phosphonobutane-1,2,4-tricarboxylic acid, and ethylenediamine tetra(methylene-phosphonic acid) pentasodium salt.

9. The composition of claim 1, wherein the phosphonate metal chelant is present in a range of from about 1% by weight of the composition to about 60% by weight of the composition.

10. The composition of claim 1, wherein the phosphonate metal chelant is present in a range of from about 2% by weight of the composition to about 40% by weight of the composition.

11. The composition of claim 1, wherein the phosphonate metal chelant is present in a range of from about 3% by weight of the composition to about 30% by weight of the composition.

12. The composition of claim 1, wherein the chelating agent is at least one of triethanolamine, monoethanolamine, N-(hydroxyethyl)-ethylenediamine triacetic acid, monoisopropanolamine, diethanolamine, aminoethylethanolamine, diethylenetriaminepentaacetic acid, 1,2-diaminopropanetetraacetic acid, 1,3-diaminopropanetetraacetic acid, or salts thereof.

13. The composition of claim 12, wherein the chelating agent further comprises ethylenediamine tetraacetic acid or salts thereof.

14. The composition of claim 1, wherein the chelating agent is present in a range of from about 0.3% by weight of the composition to about 40% by weight of the composition.

15. The composition of claim 1, wherein the chelating agent is present in a range of from about 0.5% by weight of the composition to about 30% by weight of the composition.

16. The composition of claim 1, wherein the chelating agent is present in a range of from about 0.7% by weight of the composition to about 20% by weight of the composition.

17. The composition of claim 1, wherein the composition comprises 1-60% by weight of the composition phosphonate metal chelant, 0.3-40% by weight of the composition chelating agent, and 0.01-1% by weight of the composition ferrous ions.

18. The composition of claim 1, wherein the pH ranges from about 5 to about 9.

19. The composition of claim 1, wherein the pH ranges from about 6 to about 8.

20. A composition for derusting, comprising:
(a) a phosphonate metal chelant;
(b) at least one chelating agent stabilizer, provided that when only one chelating agent is present, the chelating agent is other than EDTA;
(c) ferrous ions; and
(d) a pH ranging from about 5 to about 10.

21. A method for derusting components comprising:
contacting a rusted surface with the composition of claim 1.

22. A method for derusting components comprising:
contacting a rusted surface with the composition of claim 1, wherein the rusted surface is at least partially dissolved in a solution having a pH of greater than about 6.

23. A method for derusting components comprising:
contacting a rusted surface with the composition of claim 19.

24. A composition comprising:
(a) a phosphonate;
(b) at least one of triethanolamine and monoethanolamine;
(c) ferrous ions; and
(d) a pH ranging from about 5 to about 10.
